(19) United States
(12) Patent Application Publication
(10) Pub. No.: US 2017/0024701 A1
(43) Pub. Date: Jan. 26, 2017

(54) PROVIDING RECOMMENDATIONS BASED ON JOB CHANGE INDICATIONS

(71) Applicant: LinkedIn Corporation, Mountain View, CA (US)

(72) Inventors: Lijun Tang, San Jose, CA (US); Bing Zhao, Sunnyvale, CA (US); Kin Kan, Sunnyvale, CA (US)

(21) Appl. No.: 14/807,762

(22) Filed: Jul. 23, 2015

(51) Int. Cl. G06Q 10/10; G06F 17/30

(52) U.S. Cl. CPC G06Q 10/1053; G06F 17/30867

(57) ABSTRACT

Techniques are provided for determining one or more recommendations to a user based on job change indications. In one approach, job change indications are tracked to generate associations between job information, such as an association between a user's job title at one time and the user's job title at a later time or an association between a user's job skill and a job skill of a job position to which the user applied. A mapping (such as a translation model) is updated based on the associations. The mapping is used to determine one or more recommendations for a particular user, where the recommendations may be job openings for the particular user, candidate users for the particular user to recruit, suggestions to edit a profile of the particular user, or possible query expansions for a query of the particular user.

### TECHNICAL FIELD

The present disclosure relates to data processing and, more particularly, to tracking job change indications and providing recommendations to users based on the job change indications.

### BACKGROUND

One feature of an online job searching tool is to recommend jobs to a user of the tool. One approach for identifying jobs to recommend to a user is to compare the job title of a job posting with the current position title of the user. If the job titles match exactly, then the corresponding job is recommended to the user.

However, there are at least two disadvantages to this approach. One disadvantage is that two text strings may be completely different but semantically similar, such as “account manager” and “sales representative” or “software engineer” and “programmer.” Thus, many job postings of jobs that would be a good fit for a user may never be recommended to that user.

Another disadvantage is that many users want to apply for jobs that are more senior than their current positions. For example, a director in a tech company may be interested in applying for a vice president position in a different company. However, a strict string matching approach will never recommend such senior positions to users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram that depicts a process for providing job-related recommendations, in an embodiment;

FIG. 2 is a block diagram that depicts a system for providing job-related recommendations, in an embodiment;

FIG. 3 is a flow diagram that depicts a process for presenting job recommendations to a user, in an embodiment;

FIG. 4 is a flow diagram that depicts a process for presenting candidate recommendations to a recruiter, in an embodiment;

FIG. 5 is a flow diagram that depicts a process for presenting edit recommendations to a user, in an embodiment;

FIG. 6 is a flow diagram that depicts a process for expanding a query submitted by a user, in an embodiment;

FIG. 7 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for creating a mapping that maps first job-related information to second job-related information. In one technique, the job-related information includes job titles. Thus, one job title maps to one or more other job titles. The mapping may be created in one or multiple ways, including tracking changes in user profiles over time and determining when users (who hold current job positions) apply to other job positions.

In an embodiment, the mapping is a monolingual translation model that is trained based on analyzing user profiles maintained in an online social network.

The mapping may be used in one of multiple ways, including recommending jobs to users, recommending candidates to recruiters, recommending (or suggesting) search terms to users who are using an online search feature, expanding a query and recommending (or suggesting) job information (e.g., job titles) to a user that is editing his/her online profile.

### Process Overview

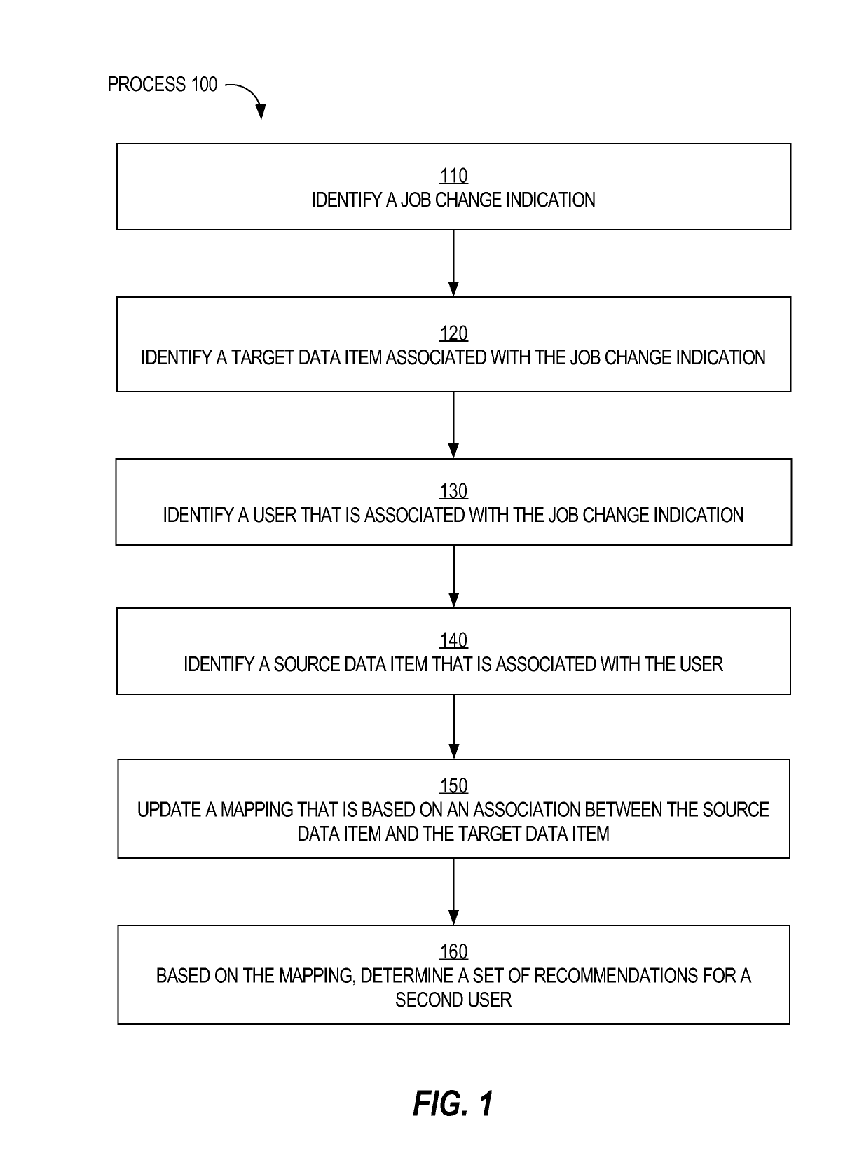

FIG. 1 is a flow diagram that depicts a process 100 for providing job-related recommendations, in an embodiment. Process 100 may be implemented in hardware, software, or any combination of hardware and software.

At block 110, a job change indication is identified. A job change indication is created based on a detection that a user updated his/her profile. For example, the user changes his job title from “Programmer” to “Senior Software Engineer.” Additionally or alternatively, a job change indication is created based on a detection that a user applied for another job position, which may be with the user's current employer or with a different employer. Thus, a “job change indication” indicates that a user changed his/her job, applied to another job, or otherwise performed an action that indicated that the user might be interested in another job.

At block 120, a target data item that is associated with the job change indication is identified. For example, if the job change indication is that the user changed his/her job title, then the current (i.e., changed) job title is identified. If the job change indication is that the user applied to another job, then the job title of the other job may be identified.

If the job change indication is associated with multiple data items, then multiple target data items are identified. For example, if a user added one or more job skills to the user's profile and added a sentence to the user's work summary of the profile, then the one or more data items and the sentence are identified.

A “data item” is a text string that comprises one or more characters and/or one or more words. If the language of the data item is a character-based language, such as Chinese, then the data item comprises one or more characters.

At block 130, a user associated with the job change indication is identified.

At block 140, a source data item that is associated with the user is identified. For example, if the job change indication is that the user changed his/her job title, then the previous job title (i.e., before the change) is identified. If the job change indication is that the user applied to another job, then the current job title of the user may be identified. Thus, in multiple scenarios, a source data item was originally provided by the user.

If the job change indication is associated with multiple target data items, then multiple source data items associated with the user may be identified. For example, if the user applies to a job that is associated with a job title, a specific job skill, and a job description, then a job title associated with the user, one or more job skills associated with the user, and a work summary associated with the user are identified.

At block 150, a mapping is updated based on an association between the source data item and the target data item. If a single job change indication causes multiple associations to be created (e.g., (1) a job title in the user's profile and a job title in a job position and (2) a job skill in the user's profile and a job skill in the job position), then the same mapping may be updated based each association or each association is used to update a different mapping. In an embodiment, the mapping is a monolingual translation model. In this embodiment, block 150 involves a training the model based on the association between the source data item and the target data item.

Blocks 120-150 may be performed in response to receiving (or otherwise detecting) each job change indication, some of which may be associated with the same user and some of which may be associated with different users. Alternatively, job change indications may be batched or grouped and later individually processed, for example, serially or in parallel. Thus, blocks 120-150 may be performed multiple times before block 160 is performed for one user.

At block 160, a set of recommendations for a second user is determined based on the mapping. The set of recommendations may vary based on context. For example, if the second user is a recruiter, then the set of recommendations may be part of a talent search that leverages the mapping to identify potential candidates for a particular job position that the recruiter is seeking to fill. If the second user is a registered member of a social network service, then the set of recommendations may identify job positions in which the second user might be interested. If the second user is searching for jobs, then the set of recommendations may be search terms that can be used in a search that is initiated by the second user. If the second user is editing his/her user profile, then the set of recommendations may be job information that the second user is likely to enter in one or more fields of the user profile. Details on how a set of recommendations is determined is described in more detail below.

### System Overview

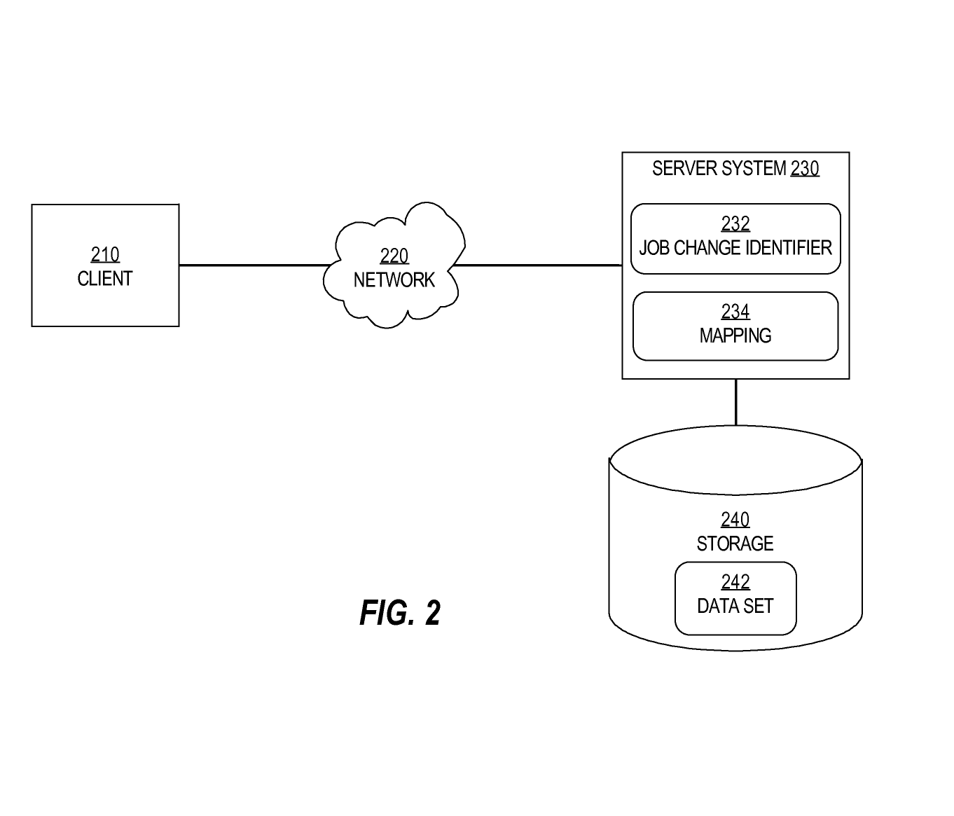

FIG. 2 is a block diagram that depicts a system 200 for providing job-related recommendations, in an embodiment. System 200 includes a client 210, a network 120, a server system 230, and storage 240.

Client 210 is an application or computing device that is configured to communicate with server system 230 over network 220. Examples of computing devices include a laptop computer, a tablet computer, a smartphone, a desktop computer, and a Personal Digital Assistant (PDA). An example of an application is a dedicated application that is installed and executed on a local computing device and that is configured to communicate with server system 230 over network 220. Another example of an application is a web application that is downloaded from server system 230 and that executes within a web browser executing on a computing device. Client 210 may be implemented in hardware, software, or a combination of hardware and software. Although only a single client 210 is depicted, system 200 may include multiple clients that interact with server system 230 over network 220.

Through client 210, a user is able to provide input that includes information about the user. Later, the user may interact with server system 230 to retrieve, supplement, and/or update the information.

Network 220 may be implemented on any medium or mechanism that provides for the exchange of data between client 210 and server system 230. Examples of network 220 include, without limitation, a network such as a Local Area Network (LAN), Wide Area Network (WAN), Ethernet or the Internet, or one or more terrestrial, satellite or wireless links.

### Storage

Storage 240 stores a data set 242 from which a mapping of source job information to target information is generated. Storage 240 may comprise persistent storage and/or volatile storage. Storage 240 may comprise multiple storage devices. Also, although depicted separately from server system 230, storage 240 may be part of server system 230 or may be accessed by server system 230 over a local network, a wide area network, or the Internet.

In an embodiment, data set 242 comprises multiple user profiles, each provided by a different user. In this embodiment, server system 230 maintains accounts for multiple users. Server system 230 may provide a web service, such as a social networking service. Examples of social networking service include Facebook, LinkedIn, and Google+. A social networking service allows members of (i.e., who have opened accounts with) the social networking service to connect to each other and share content. The various connections among members forms a logical social graph. Although depicted as a single element, server system 230 may comprise multiple computing elements and devices, connected in a local network or distributed regionally or globally across many networks, such as the Internet. Thus, server system 230 may comprise multiple computing elements other than job change identifier 232.

A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network.

### Job Change Indications

As depicted in FIG. 2, server system 230 includes a job change identifier 232 that is configured to identify or otherwise detect job change indications. A user may be allowed to update his/her profile at any time. The user's profile may be one of many user profiles (of many users) that are stored in a profile database associated with server system 230. One example of how a job change indication may be created is a user updating job information in the user's profile, for example, in response to changing jobs. A user may update his/her job information immediately after changing jobs or some time much later. Job change identifier is configured to detect when an item in a user's profile changes, identify the (now previous) item, and store an association between the previous item and the current item. For example, the previous item is a previous job title of “Programmer” and the current item is a current job title of “Senior Software Engineer.” The association may be stored as a record in a database table of job change indications. In addition to the previous and current items, a job change indication record may include a timestamp of when the change in job information occurred or was detected, an identity of the user whose profile was updated, and/or one or more attributes of the user. If information about users associated with job change indications is needed for further analysis, the user identifier included in each job change indication record may be used to retrieve user information from the corresponding user profiles of the users.

In an embodiment, only certain types of job information are tracked, such as job title, job skills, and work summary indicating what the corresponding user has done and/or learned in the past.

Another example of a job change indication is a user applying for a particular job. Even though the user may not be offered the particular job, the job application may be tracked in order to associate certain information about the particular job (e.g., job title) with certain information about the user, such as the user's current job title that is reflected in the user's profile. Job change identifier 232 is configured to detect when a user applied for a job indicated in a job posting, identify an attribute of the user (e.g., from the user's profile, such as job title), identify a corresponding attribute of the job (e.g., a job title of the job), and associate the two corresponding attributes. For example, a user's current profile lists “Java” (referring to the programming language) as a current job skill and a job to which the user applied lists “Python” as a required job skill. Accordingly, job change identifier 232 associates “Java programming language” with “Python.”

Determining that a user applies for a job may be performed in one of multiple ways. For example, a user may visit a website of an employer and submit an electronic resume (e.g., using a web browser executing on a computing device of the user) to the website. The employer then informs a third-party, such as the party that owns or operates server system 230, either manually or automatically. The informing may involve sending, to server system 230, user identifying information (e.g., a name of the user, a device identifier that identifies a computing device that the user used to interact with the website, and/or a browser cookie that identifies a web browser that the user used to interact with the website) and information about the job to which the user applied, such as job title, job skills, and a job description. In response to receiving the user identifying information and the job information, server system 230 updates a mapping by associating the job information with job-related information associated with the user (e.g., job title).

As another example, server system 230 provides a job finding service where registered members of server system 230 are able to search through job postings from multiple employers. A member may apply for a job by selecting an apply button that causes a resume associated with the member to be submitted (e.g., over network 220) to an employer associated with the corresponding job posting. Thus, server system 230 may directly track which members have applied to which jobs.

In a similar example, a member of server system 230 views multiple job postings, each of which lists some information about the corresponding job, such as job title and location. The member may then select (e.g., with a mouse pointer) one of the job postings to cause a view of additional information (e.g., job description and required job skills) about the selected job posting to be displayed to the member. Thus, a view of a specific job posting may constitute a job change indication, even though the corresponding member did not apply for the corresponding job.

### Associating Source Job Information with Target Job Information

As depicted in FIG. 2, server system 230 includes a mapping 234 that associates certain source job information with certain target job information. Mapping 234 may be stored locally or remotely with respect to server system 230.

In an embodiment, mapping 234 is a set of associations between source job data items and target job data items. A data item may be one of multiple information types, such as job title, job skill, job summary, and job description. As described previously, job change identifier 232 or another component of server system 230 creates an association of two data items in response to detecting a job change indication and stores the association in mapping 234. For example, if a user associated with a first job title changes the first job title to a second job title, then job change identifier 232 associates the first (or “source”) job title with the second (or “target”) job title and adds the association to mapping 234.

In an embodiment, an association between two data items has an order: one data item is considered the “source” and the other data item is considered the “target.” Thus, if a user is to be presented with recommendations of job positions, then a particular job title of the user is used to identify an association whose “source” data item matches the particular job title. If the particular job title is used to identify an association whose “target” data item matches the particular job title, then recommendations provided to the user may be incorrect or not as relevant.

If mapping 234 already stores the association, then the current instance of the association may be deleted or not created in the first place. Alternatively, metadata associated with the association is modified to reflect the additional instance of the association. For example, if there is already an association between “programmer” and “Senior Software Engineer” and the association is associated with a count of eleven, then the count is increased to twelve if another instance of the association is identified with respect to a job change indication.

Another example of metadata associated with an association is a first probability of a first data item given a second data item and/or a second probability of the second data item given the first data item. As a specific example, a probability of “Software Engineer” given “Programmer” (e.g., p(t|s)) may be updated based on this pair of data items being associated with a single job change indication.

In an embodiment, mapping 234 is implemented as a table where each row corresponds to a different association between a source data item and a target data item. One column of the table stores source data items and another column of the table stores target data items. Another column of the table may include count or frequency data that indicates a number of times the corresponding association has been detected or identified as a result of a job change indication. In a related embodiment, an index is created on the source data item column and/or an index is created on the target data item in order to quickly identify one or more target data items given a source data item and/or quickly identify one or more source data items given a target data item.

In an embodiment, mapping 234 comprises multiple, separate groups of associations (e.g., tables), each group associated with a different information type or type of association. Example types of associations include source job title→target job title, source job skill→target job skill, source job title→target job skill, source job skill→target job title. Thus, an association may have corresponding data items of the same type (e.g., job skill) while another association may have corresponding data items of different types (e.g., job title and job skill). For example, if a user with a particular job skill applies to a job associated with a particular job title, then an association between the particular job skill and the particular job title is created and, in the association, the particular job skill is considered the “source” data item and the particular job title is considered the “target” data item. The association is used to update mapping 234 or a first group of associations within mapping 234. Also, a second association between the user's job title and the particular job title may be created and used to update mapping 234 or a second group of associations within mapping 234. Thus, a single job change indication may result in multiple data item associations.

In an embodiment, multiple mappings are created, one for each language of multiple languages, such as English, Spanish, French, German, Chinese, Korean, and Japanese. Thus, the language associated with a job change indication is determined in order to determine which mapping to update based on the data item association of the job change indication. Then, before a mapping is used to provide a set of recommendations to a user, a language associated with the user is identified, and the mapping that corresponds to that language is selected in order to determine the set of recommendations. A language may be determined in one of multiple ways. For example, a user that provided profile information (from which an association is generated) manually specifies the language of his/her profile. Such input may be specified during registration with server system 230 or sometime after registration, such as after a successful login attempt. Specifying a language may comprise the user selecting a language from a list of languages in a drop-down menu that is displayed adjacent to user-provided profile information that is in one language. Server system 230 then stores, in association with the user's profile, data that identifies the user-selected language.

Additionally or alternatively, server system 230 automatically determines the language of a profile (i.e., without user input that identifies the language). For example, for each of one or more fields of a profile (e.g., a job title or employer name), server system 230 compares user-provided text of that field with a text corpus of known languages (e.g., English, Spanish, French, German, and Chinese). If the user-provided profile information (or at least a portion thereof) matches text from a text corpus of a particular language, then server system 230 stores, in association with the profile, language identification data that identifies the particular language. One example of a text corpus is a set of user profiles where the languages are known or have already been determined, whether determined automatically or determined based on user input that specifies the respective languages.

### Monolingual Translation Model

In an embodiment, mapping 234 is reflected in a monolingual translation model that is trained based on associations between source job information and target job information as determined based on job change indications. Embodiments are not limited to any particular type of translation model or machine learning technique. The translation model is trained based on multiple features. Example types of features include lexical reordering, distortion, word penalty, and phrase penalty, each of which is independent of the training data upon which the translation model is based.

Lexical reordering of job information phrases (e.g., job titles) may be limited, but important for understanding the job information. For instance, the job title “professor assistant” is very different than “assistant professor.” In this case, reordering is modeled during the translation via lexicalized features. Each reordering operation may be associated with 6-dimensional cost vector, encoding three reordering types: Monotone (M), Swap (S), and Discontinuous (D), and in two directions from source-to-target and target-to-source.

An example feature related to the distortion feature type is a number of moves of words within a window of N (e.g., six) words. For example, a majority of job titles in data set 242 are less than six tokens in length.

An example feature related to the word penalty feature type is a cost function that is associated with word-based translations, which involves translating a phrase word-by-word. The more each word in a target phrase is a direct translation of a word in a source phrase, the higher the cost (or penalty). With such a cost, word-to-word translation is discouraged and prefer phrase-to-phrase translation is encouraged, since phrases encode more context for better disambiguation.

An example feature related to the phrase penalty feature type is a cost function that is associated with translating phrase-by-phrase. A “phrase” is an N-gram in the source. The more each phrase in a target phrase is a translation of a phrase in a source phrase, the lower the cost (or penalty). Generally speaking, phrase translation is more preferred than word-based translations.

Examples of feature types that depend on the training data include one or more language models and a translation model. An example feature related to the language model feature type is a first language model that is learned from data for “transitions,” such as a job title change or a job application. The first language model is an N-gram, such as a 5-gram. For example, if a source job title and a candidate target job title are relatively frequent, as reflected in the first language model, then a score (generated by the first language model) for the candidate target job title may be relatively high.

In an n-gram model, the probability of observing the phrase or sentence w₁, . . . , wₘ is denoted as P(w₁, . . . , wₘ) and is approximated as:

$$P ( {w}_{1} , … , {w}_{m} ) = {\prod }_{i = 1}^{m} P ( {w}_{i} \vert {w}_{1} , … , {w}_{i - 1} ) \approx {\prod }_{i = 1}^{m} P ( {w}_{i} \vert {w}_{i - ( n - 1 )} , … , {w}_{i - 1} )$$

Here, it is assumed that the probability of observing the i^{th} word (wᵢ) in the context history of the preceding i−1 words can be approximated by the probability of observing wᵢ in the shortened context history of the preceding n−1 words.

The conditional probability may be calculated from n-gram frequency counts:

$$P ( {w}_{i} \vert {w}_{i - ( n - 1 )} , … , {w}_{i - 1} ) = \frac{count ( {w}_{i - ( n - 1 )} , … , {w}_{i - 1} , {w}_{i} )}{count ( {w}_{i - ( n - 1 )} , … , {w}_{i - 1} )}$$

For example, in a bigram (n=2) language model, the probability of the phrase “UX designer and manager” is approximated as:

P(UX, designer, and, manager)≈P(UX|<s>)P(designer|UX)P(and|designer)P(manager|and)P(</s>|manager)

whereas in a trigram (n=3) language model, the probability of the phrase “UX designer and manager” is approximated as:

P(UX, designer, and, manager)≈P(UX|<s>,<s>)P(designer|<s>,UX)P(and|UX, designer)P(manager|designer, and)P(</s>|and, manager)

The context of the first n−1 n-grams is filled with start-of-sentence markers, denoted <s>. Without an end-of-sentence marker, the probability of an ungrammatical sequence “UX designer and” would always be higher than that of the longer phrase “UX designer and manager.”

An example feature related to the language model feature type is a second language model that is learned from user profiles. The second language model is also an N-gram, such as a 5-gram. The second language model is based on a potentially much larger dataset relative to the first language model. For example, if a candidate target job title is relatively infrequent, as reflected in the second language model (e.g., there are few instances of the candidate target job title in a large set of user profiles), then a score (generated by the second language model) for the candidate target job title may be relatively low.

An example feature related to the translation model feature type is a vector of feature functions for evaluating if a phrase-pair is a good translation candidate or not. Example feature functions include p(f|e) and p(e|f) and relative frequencies of P(f|e) and P(e|f). The relative frequency of P(e|f) is computed as normalized frequencies #(e, f)/#(f), where #(f) is the total observed frequency for phrase f and #(e,f) is the frequency for the phrase pair (e,f).

The feature function p(e|f), on the other hand, is a lexical p(e|f), which is computed using word-level alignment between phrase e and phrase f. For example, if e=e₁ e₂, f=f₁ f₂, and there is full alignment between eᵢ and fⱼ, then

$$p ( e \vert f ) = {\prod }_{i = 1 … I} ( 1 / J {\sum }_{j = 1 … J} p ( {e}_{i} \vert {f}_{j} ) ) = [ 1 / 2 ( p ( {e}_{1} \vert {f}_{1} ) + p ( {e}_{1} \vert {f}_{2} ) ) ] * [ 1 / 2 ( p ( {e}_{2} \vert {f}_{1} ) + p ( {e}_{2} \vert {f}_{2} ) ] .$$

In an embodiment, multiple monolingual translation models are created, one for each information type or type of association. For example, one monolingual translation model is created for source job title→target job title, one monolingual translation model is created for target job title→source job title, another monolingual translation model is created for source job skill→target job skill, another monolingual translation model is created for source job title→target job skill, and so forth.

### Job Recommendation

In an embodiment, mapping 234 is used to generate one or more job recommendations for a particular user. Server system 230 may include a job recommender (not depicted in FIG. 2) that is configured to identify one or more job positions in which a user might be interested. The job recommender may be implemented in hardware, software, or any combination of hardware and software. The job recommender may take into account multiple inputs, not just current job information of a user (e.g., job title and/or job skill) and mapping 234. For example, the job recommender may determine whether the user is connected, in a social graph, with one or more other users who are currently employed by the employer that is offering the job position. If so, then that job position may be ranked higher than other possible job positions that might be presented to the user.

The job recommender may cause one or more job recommendations to be presented to a user when the user logs into an online service (such as a social networking service) provided by server system 230. Additionally or alternatively, the one or more job recommendations may be presented to the user when the user visits certain web pages provided by server system 230, such as a home page, a profile page, and/or a search page. Additionally or alternatively, the one or more job recommendations may be sent in an email message addressed to an email account associated with the user.

In an embodiment, the job recommender sends a request (e.g., an API call) to another component (referred to herein as a “translator”) that is responsible for identifying, and returning to the job recommender, target job information given source job information that is included in the request. For example, the request may include a particular job title of a particular user and may indicate that one or more target job titles are requested. The translator uses the particular job title and mapping 234 to identify one or more target job titles that are associated with the particular job title.

In an embodiment, the request from the job recommender identifies an “information type” (or “context type”), such as job title, job skill, job summary, etc. The translator then uses the information type to identify and return the appropriate job information. For example, the translator has access to multiple translation models, one that is generated and trained for each information type. Alternatively, there are multiple translators, each for a different information type. For example, the job recommender selects, from among a plurality of translators, a particular translator that is associated with the current information type (e.g., job title) and then sends, to the selected translator, the job information related to a particular user. The selected translator may include a translation model that is built for the determined information type and that returns a set of target job information (e.g., multiple target job titles) to the job recommender.

In an embodiment, the target job information that the job recommender receives from a translator include score or ranking information that is associated with each target job data item in the target job information. For example, if the job recommender receives four target job titles from the translator, then the job recommender also receives four scores, one for each target job title. As another example, the order in which the four target job titles are received implies a ranking from highest (or best) to lowest (or worst). The job recommender may use the score or ranking information to determine whether or how to use the target job information. For example, if a target job title is associated with a score that is above a particular threshold, then the job recommender uses the target job title to match against job titles in a set of job positions. If a target job title is associated with a score that is below the particular threshold, then the job recommender may ignore the target job title.

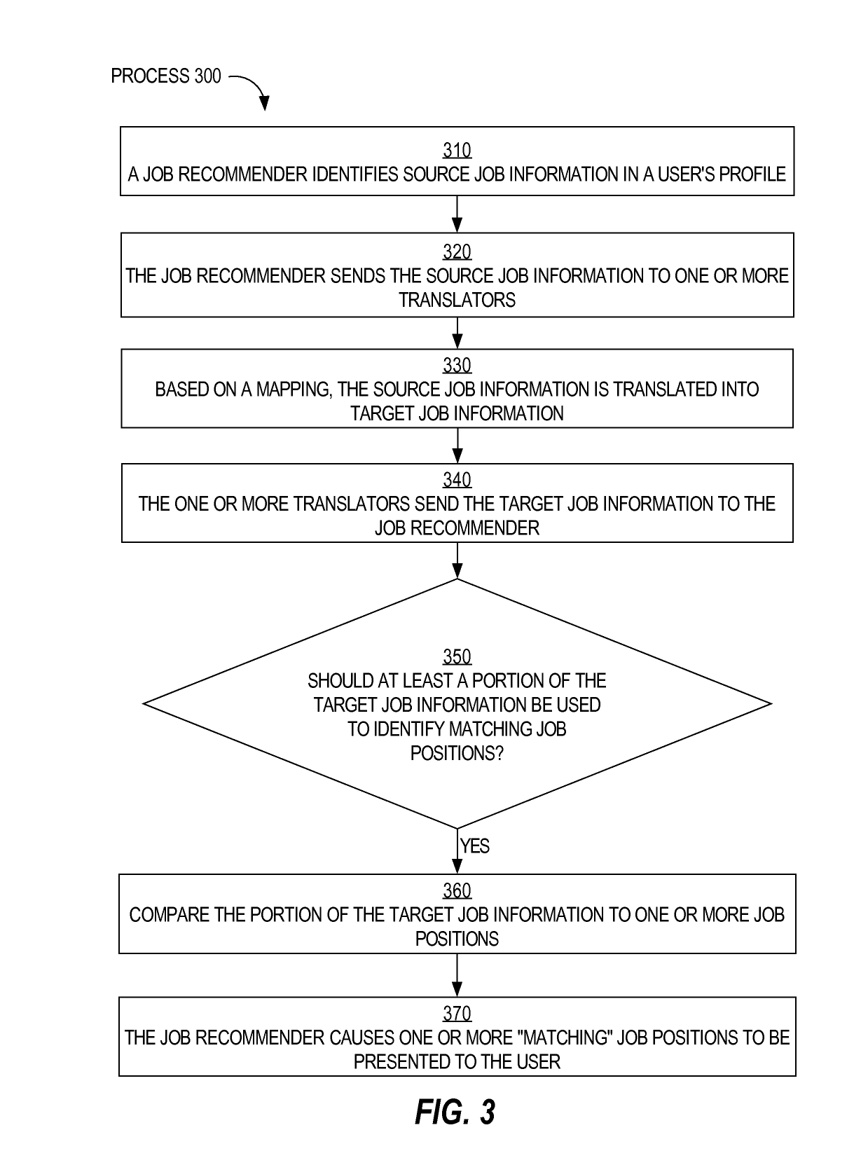

FIG. 3 is a flow diagram that depicts a process 300 for presenting job recommendations to a user, in an embodiment. Process 300 may be implemented by server system 230. Process 300 may be repeated for user of server system 230 or each member of a social network service. Process 300 may be initiated when a new user logs onto server system 230, when a user edits his/her profile, when a new job position is uploaded to server system 230, and/or when an existing job position is edited or otherwise modified. Additionally or alternatively, process 300 may be initiated after the lapse of a particular period of time, such as every ten days.

At block 310, a job recommender identifies one or more data items in a user's profile, such as a current job title or a current job skill. The one or more data items are considered “source” job information.

At block 320, the job recommender sends the source job information to one or more translators.

At block 330, the one or more translators translate, based on mapping 234, the source job information (or a portion thereof) into target job information.

At block 340, the one or more translators send the target job information to the job recommender.

At block 350, the job recommender determines whether to use the target job information or a subset thereof to identify one or more job positions. If so, then process 300 proceeds to block 360. Thus, the job recommender may filter some of the target job information before block 360. For example, if the job recommender receives four job titles from a translator, then the job recommender might determine that only two of the job titles should be presented to the user. As another example, if the job recommender receives a job title from one translator and a job skill from another translator, then the job recommender might determine to present the job skill but not the job title.

At block 360, the job recommender compares the target job information (or a portion thereof) with job information of one or more job positions to identify one or more job positions. For example, if the target job information includes job titles “Senior Software Engineer” and “Senior Programmer” and a particular job position of a number of current job positions has a job title “Senior Programmer,” then the particular job position is considered a “matching job position.”

Block 360 may involve limiting the comparison to certain portions of the job positions. For example, if the job recommender determines that the target job information is of job title information type, then the job recommender compares the target job information with only job titles of the job positions.

At block 370, the job recommender causes one or more “matching” job positions (i.e., that match the target job information) to be presented to the user. For example, server system 230 sends, over network 220, to client 210, data about the one or more job positions. The data may initially include (1) a list of employer names associated with the “matching” job position(s), (2) one or more additional pieces of information about each job position, such as job title, job skills, job description, and (3) a link that, when selected, causes a more detailed profile of the corresponding job position to be displayed. Block 370 may occur much later in time relative to the other blocks of process 300 if, for example, the user does not log into his/her account (that is maintained by server system 230) for a relatively long period of time.

The job recommender may also take into account other information or criteria when determining which job positions to present to the user. The other information or criteria may cause some of the matching job positions identified in block 360 to not be presented to the user in block 370. Additionally or alternatively, the other information or criteria may cause other job positions (not identified as a result of block 360) to be presented to the user in block 370.

### Talent Match

In an embodiment, mapping 234 is used to generate one or more job recommendations for a particular recruiter. Server system 230 may include a candidate recommender (not depicted in FIG. 2) that is configured to identify one or more candidate users that might satisfy one or more recruiting criteria.

Previously, recruiters might search for candidates to fill a job position with a particular job title by inputting the particular job title into a search interface (e.g., provided by server system 230) and a search engine matching the particular job title to users or members of a social network who have the same job title. Alternatively, a recruiter might manually fill in details of a job position into an online form and initiate a search (e.g., by selecting a graphical user interface button) where a search engine uses the filled-in job information to search for users who are deemed similar enough to the filled-in job information. Again, exact matches are typically required.

In this embodiment, however, the candidate recommender leverages mapping 234 to translate target job information (e.g., a target job title or a target job skill) associated with a job position into source job information (e.g., one or more source job titles and/or one or more source job skills).

The candidate recommender may be implemented in hardware, software, or any combination of hardware and software. The candidate recommender may take into account multiple inputs, not just job information of a job position (e.g., job title and/or job skill) and mapping 234. For example, the candidate recommender may determine whether a candidate is connected, in a social graph, with one or more other users who are currently employed by the employer that is offering the job position. If so, then that candidate may be ranked higher than other possible candidates that might be presented to a recruiter.

In an embodiment, the candidate recommender sends a request (e.g., via an API call) to another component (referred to herein as a “translator”, which may be the same as or different than the translator with which the job recommender communicates) that is responsible for identifying, and returning to the candidate recommender, one or more source job information given target job information that is included in the request. For example, the request may include a particular job title of a particular job position and may indicate that one or more source job titles are requested. The translator uses the particular job title and mapping 234 to identify one or more source job titles that are associated with the particular job title.

In an embodiment, the request from the candidate recommender identifies an information type, such as job title, desired skill, and job description. The translator then uses the information type to identify and return the appropriate job information given the specific target job information. For example, the translator has access to multiple translation models, one that is generated and trained for each information type. Alternatively, there are multiple translators, each for a different information type. For example, the candidate recommender selects, from among a plurality of translators, a particular translator that is associated with the current information type (e.g., job title) and then sends, to the selected translator, the job information related to a particular job position. The selected translator may include a translation model that is built for the determined information type and that returns a set of source job information (e.g., multiple source job titles) to the candidate recommender.

In an embodiment, the source job information that the candidate recommender receives from a translator include score or ranking information that is associated with each source job data item in the source job information. For example, if the candidate recommender receives four source job titles, then the candidate recommender also receives four scores, one for each source job title. As another example, the order in which the four source job titles are received implies a ranking from best to worst. The candidate recommender may use the score or ranking information to determine whether or how to use the source job information. For example, if a source job title is associated with a score that is above a particular threshold, then the candidate recommender uses the source job title to match against job titles in a set of user profiles. If a source job title is associated with a score that is below the particular threshold, then the candidate recommender may ignore the source job title.

Not all users of server system 230 may be able to leverage a candidate recommender. In an embodiment, a recruiter is a specialized user that has an account with a candidate search system provided by an entity, which may be the same as the entity that provides server system 230. The account may be associated with (e.g., subscribed-for) privileges that allows the recruiter to search across user profiles for potential candidates that satisfy one or more hiring criteria. Other users of server system 230 may not have this capability or may have limited (or restricted) use of this capability, such as in terms of number of searches, the scope of each search, and/or number of candidates identified for each search.

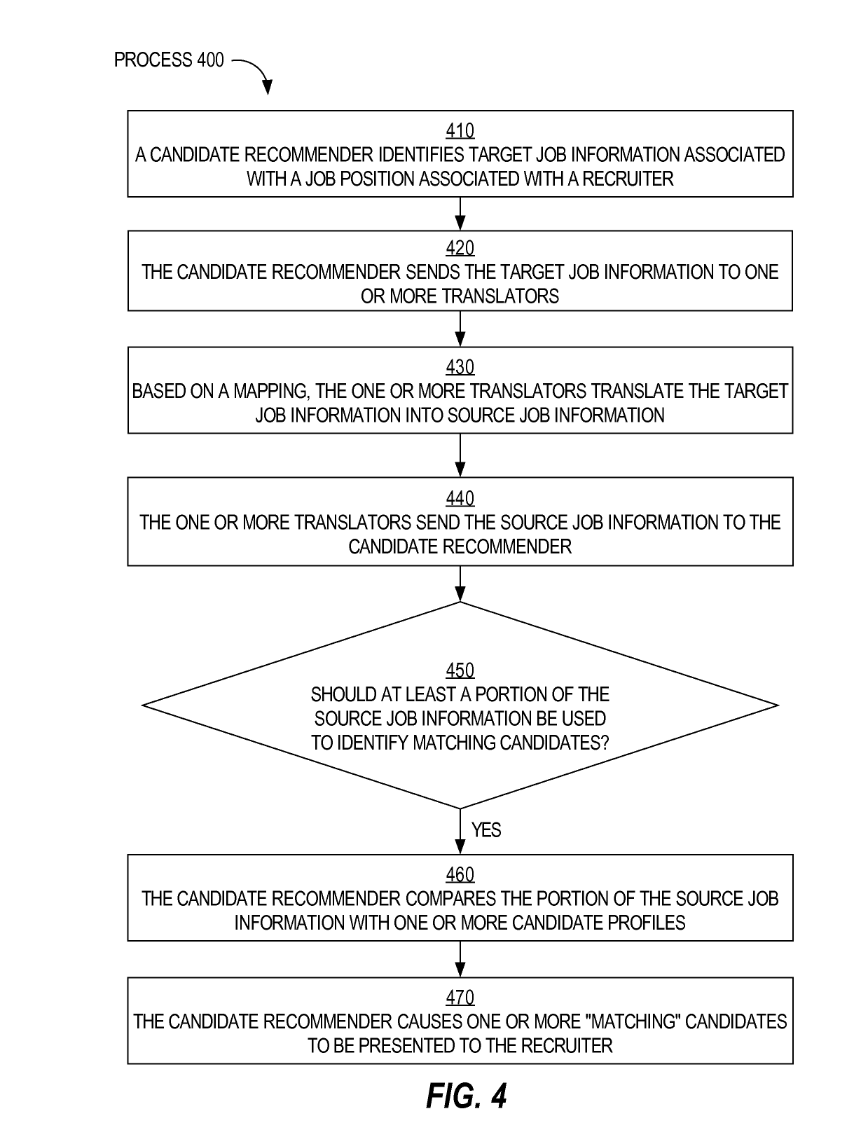

FIG. 4 is a flow diagram that depicts a process 400 for presenting candidate recommendations to a recruiter, in an embodiment. Process 400 may be implemented by server system 230. Process 400 may be repeated for each job position identified (or submitted) by the recruiter or other individuals. Process 400 may be initiated whenever a recruiter logs onto server system 230, when a new job position (that satisfies certain criteria specified by the recruiter) is uploaded to server system 230, and/or when an existing job position (that satisfies certain criteria specified by the recruiter) is edited or otherwise modified. Additionally or alternatively, process 400 may be initiated after the lapse of a particular period of time, such as every ten days.

At block 410, a candidate recommender identifies one or more data items associated with a job position, such as a current job title or a current job skill. The one or more data items are considered “target” job information.

Block 410 may be initiated when a recruiter identifies the job position and provides input that causes server system 230 to identify candidates that might be interested in the job position. The recruiter may be affiliated with the job position, such as an HR employee at an employer that has one or more openings for the job position.

At block 420, the candidate recommender sends the target job information to one or more translators.

At block 430, the one or more translators translate, based on mapping 234, the target job information (or a portion thereof) into source job information.

At block 440, the one or more translators send the source job information to the candidate recommender.

At block 450, the candidate recommender compares the source job information (or a portion thereof) with job information of one or more candidate profiles. For example, if the source job information includes “Python” as a job skill and a candidate profile lists “Python” as a job skill, then the candidate profile is considered a “matching candidate profile.”

Block 450 may involve limiting the comparison to certain portions of candidate profile(s). For example, if the candidate recommender determines that the source job information is of the job skill information type, then the candidate recommender compares the source job information with only data items, within the candidate profiles, that are labeled as skills.

At block 460, the candidate recommender causes one or more matching candidate profiles to be presented to the recruiter. For example, server system 230 sends, over network 220, to client 210 (if the recruiter is operating client 210), data about the one or more candidates that correspond to the one or more candidate profiles. The data may initially include (1) a list of names of the “matching” candidates, (2) one or more pieces of information about each candidate, such as job title, current employer, etc., and (3) a link that, when selected, causes a profile of the corresponding candidate to be displayed. Block 460 may occur much later in time relative to the other blocks of process 400 if, for example, the recruiter does not log into his/her account that is maintained by server system 230 for a relatively long period of time.

The candidate recommender may also take into account other information or criteria when determining which candidate profiles to present to the recruiter. The other information or criteria may cause some of the matching candidate profiles identified in block 450 to not be presented to the recruiter in block 460. Additionally or alternatively, the other information or criteria may cause other candidate profiles (not identified as a result of block 450) to be presented to the recruiter in block 460.

### Edit Recommendations

In an embodiment, server system 230 allows users to enter information about themselves, such as job information. Server system 230 provides an interface that includes fields, menus, and/or buttons for users to interact with in order to receive user information, such as name, residence, age, gender, job title, employer name, work history, etc.

A user may enter personal information as part of an initial registration process with server system 230 and/or as part of an edit process after the user has registered with a service provided by server system 230. The entirety of the entered personal information is considered part of the user's profile.

In an embodiment, mapping 234 is used to generate one or more edit recommendations for a particular user, such as a member of a social network service. Server system 230 may include one or more edit recommenders (not depicted in FIG. 2), each of which is configured to identify one or more words or phrases and recommend them to a particular user. For example, one edit recommender may be configured to recommend a job title to a user, another edit recommender may be configured to recommend a job skill to the user, and another edit recommender may be configured to recommend a job description to the user. Thus, each edit recommender may be created for each information type (e.g., job title, job skill, etc.). Additionally or alternatively, server system 230 includes a single edit recommender for multiple (e.g., all) information types.

Each recommendation is based on information that a user has previously entered. For example, if a job title of a user is “Programmer,” then that job title is treated as a source job title, which is used as input to mapping 234 in order to identify one or more target job titles, or “edit recommendations.”

An edit recommendation may be presented (e.g., displayed) to a user before the user has modified his/her current profile information. Thus, an edit recommendation may be provided (or otherwise presented) to the user without requiring input from the user (other than the current profile information). For example, a user registers with a social network service and provides profile information on Day 1 and later, on Day 10, the social network service provides an edit recommendation to the user.

Alternatively, an edit recommendation may be determined (or at least displayed to a user) in response to determining that the user is viewing his/her profile, updating any portion of the profile, or updating a certain portion of the profile. For example, in response to determining that the user erases a current job title, one or more edit recommendations (i.e., one or more target job titles in this example) are determined (based on mapping 234) and displayed to the user.

As another example, in response to determining that the user replaces a current job title with one or more characters, one or more target job titles are determined (based on mapping 234) and displayed to the user. Thus, an edit recommendation may be presented to a user while the user is typing or otherwise providing input. (A “character” may be, for example, an English or French character or a character in a character-based language, such as Chinese, Japanese, or Korean.) The one or more target job information (or job titles in this example) that is displayed to the user may be limited to job titles that begin with the one or more characters that the user has entered (or otherwise provided) thus far. For example, if a user's current job title is “Programmer” and the user replaces the job title with “S”, then target job profiles are limited to job titles that begin with “s”, such as “Software Engineer,” “Senior Software Engineer,” “Senior Engineer,” and “Software Developer.” If the user then types in “o”, then “Senior Software Engineer” may be removed from display.

Similar to the job recommender and the candidate recommender described previously, an edit recommender may be configured to communicate with (e.g., via one or more API calls) a translator that “translates” input provided by the edit recommender into one or more candidate data items (e.g., job titles or job skills) and send the one or more candidate data items to the edit recommender in response. The edit recommender may choose to present a subset of the candidate data items based on a score or ranking associated with each candidate data item.

Also similar to the job recommender and the candidate recommender described previously, there may be a single translator with which one or more edit recommender interacts or there may be multiple translators, one translator for each information type.

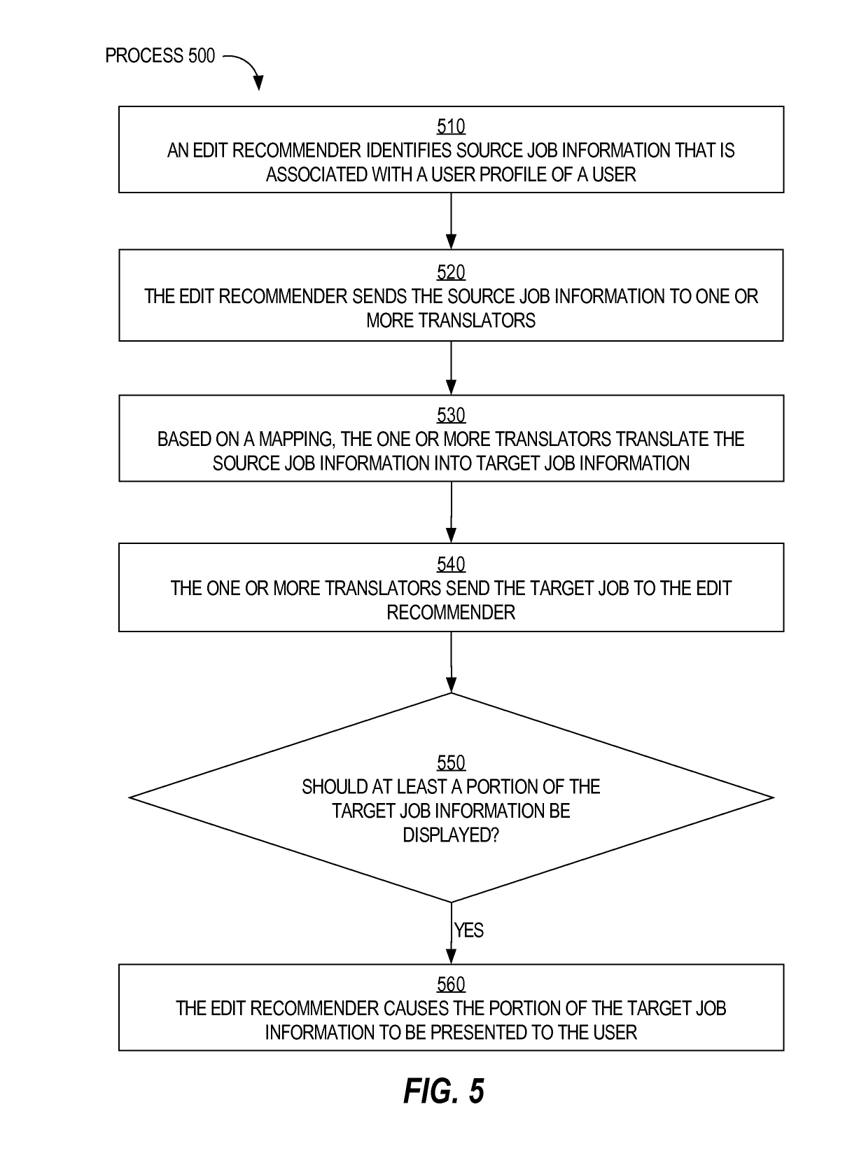

FIG. 5 is a flow diagram that depicts a process 500 for presenting edit recommendations to a user, in an embodiment. Process 500 may be implemented by server system 230. Process 500 may be repeated for each data item of a user's profile and for multiple users. Process 500 may be initiated whenever a user logs onto server system 230, when the user views a profile edit page, and/or when the user modifies a profile data item, such as a job title. Additionally or alternatively, process 500 may be initiated after the lapse of a particular period of time. For example, process 500 may be performed regardless of whether the user has changed his/her profile or has even visited a web site hosted by server system 230.

At block 510, an edit recommender identifies one or more data items associated with a user profile, such as a current job title or a current job skill. The one or more data items are considered “source” job information. The one or more data items may be identified in response to determining that the user profile is being presented (or was recently sent) to the user associated with the user profile. Additionally or alternatively, the one or more data items are identified in response to detecting that the user has modified the one or more data items.

At block 520, the edit recommender sends the source job information to one or more translators.

At block 530, the one or more translators translate, based on mapping 234, the source job information (or a portion thereof) into target job information. The target job information may be of a different information type than the source job information. For example, the source job information may be a job skill (reflected in the user's profile) and the target job information may be a job title that is identified based on the job skill using mapping 234.

At block 540, the one or more translators send the target job information to the edit recommender.

At block 550, the edit recommender determines whether to display the target job information or a subset thereof. If so, then process 500 proceeds to block 560.

At block 560, the edit recommender causes the target job information to be presented through a computing device of the user. For example, server system 230 sends, to client 210, the target job information and causes the target job information to be displayed on a display screen associated with client 210. If the target job information comprises multiple data items (e.g., multiple job titles), then the multiple data items may be displayed in any number of ways, such as a vertical list or drop down menu.

### Query Expansion

In an embodiment, server system 230 allows a user to initiate a search of data set 242, which may comprise multiple user profiles and/or information on current job positions. A search engine (not depicted in FIG. 2) receives a query of one or more terms and compares the one or more terms to data within user profiles or data within job postings or both.

In an embodiment, mapping 234 is used to expand a query. A search interface may comprise a single input (e.g., text) field or multiple fields and, optionally, menus, buttons, and/or check boxes. The search interface may allow a user to specify an information type, such as job title, job skills, work summary, and job description. For example, a user might select a check box adjacent to the phrase “Job Title,” indicating that the user desires to search for job postings by job title. The search engine (or a component that sends search terms of a query to the search engine) uses mapping 234 to expand the one or more search terms provided by the user. For example, if the user enters “Programmer,” then a query expander (not depicted in FIG. 2) may identify, based on mapping 234, “Software Engineer,” “Senior Software Engineer,” “Senior Engineer,” and “Software Developer.” One or more of these target job titles (and, optionally, the “source” job title) are sent and processed by the search engine to identify one or more job postings that match any of the source and/or target job titles.

In the above example, the query submitter is an individual searching for a job. In another example, a query submitter is an individual searching for candidates who might qualify for a job. In this scenario, one or more search terms that are entered are treated as target job information and the target job information and mapping 234 are used to identify source job information, which is compared to user profiles to identify user profiles that include or match the source job information, or a portion thereof.

In an embodiment, there is a single query expander that is responsible for expanding all queries submitted to a search system. Alternatively, there may be multiple query expanders for a search system, one for each information type. For example, one query expander is for translating search terms related to job titles, another query expander is for translating search terms related to job skills, and another query expander is for translating search terms related to job summaries or job descriptions.

Similar to the job recommender and the candidate recommender described previously, a query expander may be configured to communicate with a translator that “translates” input provided by the query expander into one or more candidate data items (e.g., job titles or job skills) and send the one or more candidate data items to the query expander in response. The query expander may choose to use a subset of the candidate data items (in a search) based on a score or ranking associated with each candidate data item.

Also similar to the job recommender and the candidate recommender described previously, there may be a single translator with which a query expander interacts or there may be multiple translators, one translator for each information type.

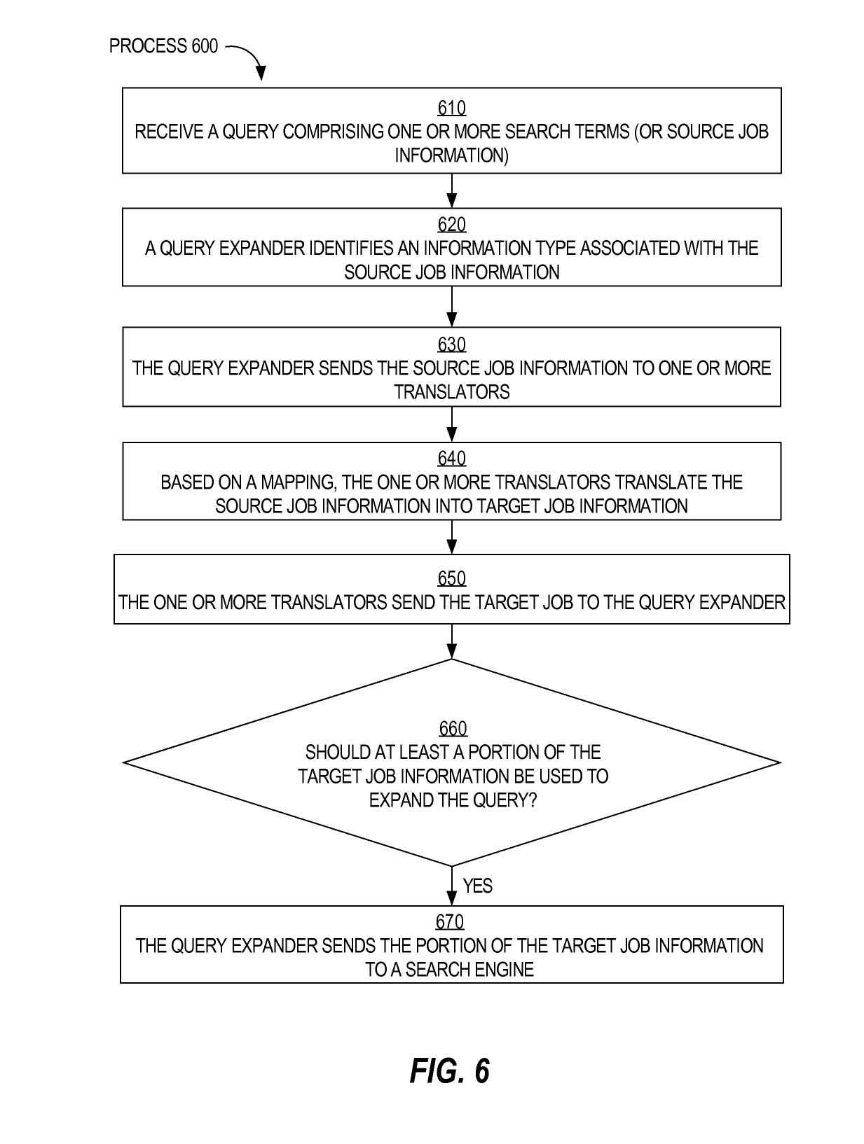

FIG. 6 is a flow diagram that depicts a process 600 for expanding a query submitted by a user, in an embodiment. Process 600 may be implemented by server system 230. Process 600 may be repeated for each query submitted by the user and for multiple users.

At block 610, a query comprising one or more search terms is received, such as “Software Engineer.” The one or more search terms may have been entered by a user. Alternatively, the one or more search items are not received as input from the user. Instead the one or more search items are a profile data item of the user. The profile data item (e.g., job title) is automatically identified in response to input from the user, such as a selection of a button or link that, when selected, indicates that the user would like to view job postings that the user might be interested in.

At block 620, a query expander identifies an information type for the one or more search terms, such as job title or job skill. The one or more search terms are considered “source” job information. The one or more data items may be identified in response to detecting that the user has modified the one or more data items. Block 620 is optional if there is only one information type that a user may search on, such as job title or job skills.

At block 630, the query expander sends the source job information to one or more translators.

At block 640, the one or more translators translate, based on mapping 234, the source job information (or a portion thereof) into target job information.

At block 650, the one or more translators send the target job information to the query expander.

At block 660, the query expander determines whether to expand the query to include the target job information or a portion thereof. If so, then process 600 proceeds to block 670. For example, if the target job information includes multiple data items (e.g., job titles) and each data item is associated with a different score, then the query expander may select a subset of the data item items based on the score or other criterion.

At block 670, the query expander sends the target job information (and, optionally, the source job information) to a search engine that performs a search based on the target job information.

As a result of performance of the search, one or more job positions are identified and returned to the user that submitted the one or more search terms. For example, server system 230 sends, to client 210, the results of the search and causes the results to be displayed on a display screen associated with client 210. In this way, a user searching for job positions associated with, for example, one job title, may discover job positions associated with multiple semantically similar job titles.

In an alternative embodiment to block 670, query expander causes the target job information to be displayed to the user as suggestions to use in a search instead of using the target job information to perform the search automatically without further user input.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

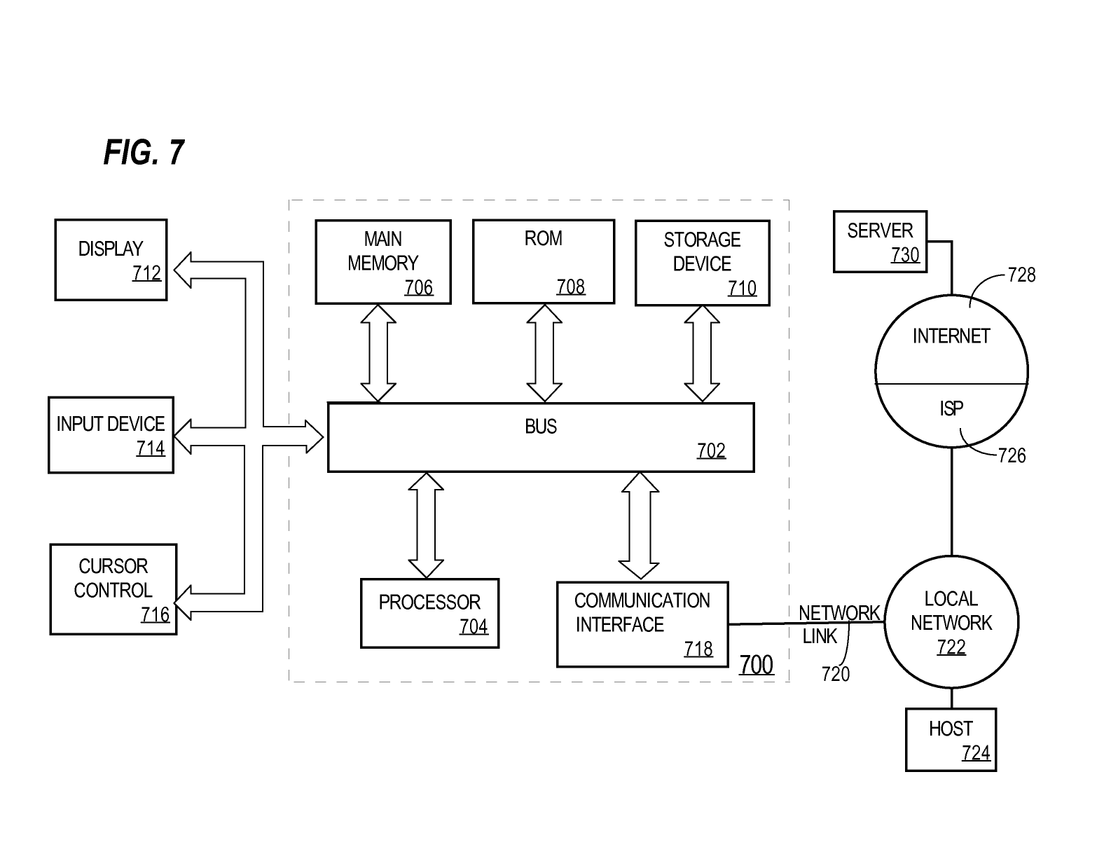

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a plurality of job change indications;
for each job change indication of the plurality of job change indications:
identifying a user that is associated with said each job change indication;
identifying a source data item that is associated with the user;
identifying a target data item that is associated with said each job change indication;
storing an association between the source data item and the target data item;
updating a mapping based on the association between the source data item and the target data item;
based on the mapping, determining a set of recommendations for a particular user;
wherein the method is performed by one or more computing devices.

2. The method of claim 1, further comprising:
identifying job information that is associated with the particular user;
wherein determining the set of recommendations comprises determining the set of recommendations based on the job information and the mapping;
wherein each recommendation in the set of recommendations identifies a different job in a set of jobs;
causing the set of recommendations to be presented to the particular user.

3. The method of claim 1, further comprising:
identifying job information that is associated with a particular job;
wherein determining the set of recommendations comprises determining the set of recommendations based on the job information and the mapping;
wherein each recommendation in the set of recommendations identifies a different candidate user in a set of candidate users;
causing the set of recommendations to be presented to the particular user.

4. The method of claim 1, further comprising:
determining that a user profile of the particular user is being presented to the particular user;
identifying job information that is associated with the particular user;
wherein determining the set of recommendations comprises determining the set of recommendations based on the job information and the mapping;
wherein each recommendation in the set of recommendations is a suggestion for a different job title in a set of job titles;
causing the set of recommendations to be presented to the particular user.

5. The method of claim 1, further comprising:
determining that the particular user has initiated a query;
identifying job information that is associated with the particular user;
wherein determining the set of recommendations comprises:
determining the set of recommendations in response to receiving the query;
determining the set of recommendations based on the job information and the mapping;
wherein each recommendation in the set of recommendations is a different set of one or more search terms.

6. The method of claim 5, further comprising:
causing the set of recommendations to be displayed while the first user is entering one or more characters into a search text field;
wherein the one or more characters match each recommendation in the set of recommendations.

7. The method of claim 1, further comprising:
determining that a first user replaced, in a user profile of the first user, first job information with second job information;
in response to determining that the first user replaced the first job information with the second job information, creating a job change indication;
wherein the plurality of job change indications includes the job change indication.

8. The method of claim 1, further comprising:
determining that a first user in applied for a particular job that is associated with second job information;
in response to determining that the first user in applied for the particular job, creating a job change indication;
wherein the plurality of job change indications includes the job change indication.

9. The method of claim 1, wherein:
creating the mapping comprises training a monolingual translation model based on a correspondence between the source data item and the target data item;
determining the set of recommendations based on the mapping comprises using the model and particular job information as input to the model to identify the set of recommendations for the particular user.

10. The method of claim 1, wherein:
the plurality of job change indications includes a first job change indication and a second job change indication;
the first job change indication is associated with a first user;
the second job change indication is associated with a second user that is different than the first user;
the particular user is different than the first user and the second user.

11. The method of claim 1, wherein the method is performed by a social network service that manages a plurality of user accounts, each of which is associated with a different user of a plurality of users that have registered with the social network service.

12. The method of claim 1, wherein the mapping is a first mapping that is associated with a first information type and that is different than a second mapping that is associated with a second information type that is different than the first information type, further comprising:
identifying a second plurality of job change indications;
for each job change indication of the second plurality of job change indications:
identifying a second user that is associated with said each job change indication;
identifying a particular source data item that is associated with the second user;
identifying a particular target data item that is associated with said each job change indication;
updating the second mapping that is by associating the particular source data item with the particular target data item;
based on the second mapping, determining a second set of recommendations for a second particular user.

13. The method of claim 12, wherein the first information type is one of job title, job skill, or job summary.

14. The method of claim 1, wherein:
for a particular job change indication of the plurality of job change indications:
the source data item is a first source data item;
the target data item is a first target data item;
the user is a first user;
the method further comprising, for the particular job change indication:
identifying a second source data item that is different than the first source data item and that is associated with the first user;
identifying a second target data item that is different than the first target data item and that is associated with the first user;
associating the second source data item with the second target data item.

15. A system comprising:
one or more processors;
one or more computer-readable media carrying instructions which, when executed by one or more processors, further cause:
identifying a plurality of job change indications;
for each job change indication of the plurality of job change indications:
identifying a user that is associated with said each job change indication;
identifying a source data item that is associated with the user;
identifying a target data item that is associated with said each job change indication;
storing an association between the source data item and the target data item;
updating a mapping based on the association between the source data item and the target data item;
based on the mapping, determining a set of recommendations for a particular user.

16. The system of claim 15, wherein the instructions, when executed by the one or more processors, further cause:
identifying job information that is associated with the particular user;
wherein determining the set of recommendations comprises determining the set of recommendations based on the job information and the mapping;
wherein each recommendation in the set of recommendations identifies a different job in a set of jobs;
causing the set of recommendations to be presented to the particular user.

17. The system of claim 15, wherein the instructions, when executed by the one or more processors, further cause:
identifying job information that is associated with a particular job;
wherein determining the set of recommendations comprises determining the set of recommendations based on the job information and the mapping;
wherein each recommendation in the set of recommendations identifies a different candidate user in a set of candidate users;
causing the set of recommendations to be presented to the particular user.

18. The system of claim 15, wherein the instructions, when executed by the one or more processors, further cause:
determining that a user profile of the particular user is being presented to the particular user;
identifying job information that is associated with the particular user;
wherein determining the set of recommendations comprises determining the set of recommendations based on the job information and the mapping;
wherein each recommendation in the set of recommendations is a suggestion for a different job title in a set of job titles;
causing the set of recommendations to be presented to the particular user.

19. The system of claim 15, wherein the instructions, when executed by the one or more processors, further cause:
determining that the particular user has initiated a query;
identifying job information that is associated with the particular user;
wherein determining the set of recommendations comprises:
determining the set of recommendations in response to receiving the query;
determining the set of recommendations based on the job information and the mapping;
wherein each recommendation in the set of recommendations is a different set of one or more search terms.

20. The system of claim 19, wherein the instructions, when executed by the one or more processors, further cause:
causing the set of recommendations to be displayed while the first user is entering one or more characters into a search text field;
wherein the one or more characters match each recommendation in the set of recommendations.
